(19) United States
(12) Patent Application Publication
(10) Pub. No.: US 2010/0330334 A1
(43) Pub. Date: Dec. 30, 2010

(54) ARTIFICIAL LEATHER AND METHOD FOR MANUFACTURING THE SAME

(75) Inventors: Chung-Chih Feng, Kaohsiung (TW); Pai-Hsiang Wu, Kaohsiung (TW); Jung-Ching Chang, Kaohsiung (TW); Yuan-Fang Tsai, Kaohsiung (TW); Jui-Che Chang, Kaohsiung (TW)

Correspondence Address: WPAT, PC;INTELLECTUAL PROPERTY ATTORNEYS, 2030 MAIN STREET, SUITE 1300, IRVINE, CA, 92614, US

(73) Assignee: SAN FANG CHEMICAL INDUSTRY CO., LTD., Kaohsiung (TW)

(21) Appl. No.: 12/688,148

(22) Filed: Jan. 15, 2010

(30) Foreign Application Priority Data
Jun. 24, 2009 (TW) 098121251

(51) Int. Cl. D06N 3/14; D06N 3/00; B05D 1/36; B05D 3/12; B44C 1/165

(52) U.S. Cl. 428/142; 428/151; 427/258; 427/240; 156/230

(57) ABSTRACT

The present invention relates to an artificial leather and a method for manufacturing the same. According to the method of the invention, an elastic layer is disposed on a surface of a base material, a color pattern layer is disposed on an uneven surface of the elastic layer and a cover layer covers the color pattern layer, so as to form the artificial leather. The elastic layer includes a plurality of sparkling materials. By utilizing the sparkling materials, the color pattern layer and the uneven surface, the artificial leather has a sparkling effect at various angles by showing the gradation of the stacking particles (sparkling materials). In addition, the cover layer can protect the color pattern layer on the elastic layer, so that the color pattern layer has excellent sturdiness against peeling and light.

### BACKGROUND OF THE INVENTION

1. Field of the Invention

The present invention relates to an artificial leather and a method for manufacturing the same, and more particularly to an artificial leather having a sparking effect and excellent sturdiness against peeling and light, and a method for manufacturing the same.

2. Description of the Related Art

In conventional art, an artificial leather having multi-color patterns is mostly obtained by printing the patterns on a cover layer of the artificial leather by using a wheel, in which the patterns are graved on a surface of the wheel. However, if multi-color artificial leather is to be manufactured, the artificial leather is painted by using a plurality of groups of wheels, so as to directly perform the multi-color printing on the cover layer of the artificial leather. In the conventional art, no preferred technology for fabricating the artificial leather having multi-color patterns with a high sturdiness against peeling exists, so it is much more difficult to manufacture artificial leather having the multi-color patterns with the high sturdiness against peeling. Therefore, artificial leather having multi-color patterns mostly has lower sturdiness against peeling.

Consequently, there is an existing need for an artificial leather and a method for manufacturing the same to solve the above-mentioned problems.

### SUMMARY OF THE INVENTION

The present invention is directed to an artificial leather, which includes a base material, an elastic layer, a color pattern layer, and a cover layer. The elastic layer is disposed on a surface of the base material, has an uneven surface, and includes a plurality of sparkling materials. The color pattern layer is disposed on the uneven surface. The cover layer covers the color pattern layer.

The present invention is further directed to a method for manufacturing an artificial leather, which includes: (a) providing a base material; (b) disposing an elastic layer on a surface of the base material, in which the elastic layer has an uneven surface and includes a plurality of sparkling materials; (c) disposing a color pattern layer on the uneven surface; and (d) disposing a cover layer to cover the color pattern layer.

In the artificial leather and the method for manufacturing the same according to the present invention, the color pattern layer is disposed on the uneven surface, and by utilizing the sparkling materials, the color pattern layer, and the uneven surface, the artificial leather has a sparkling effect at various angles by showing the gradation of the stacking particles. In addition, the cover layer can protect the color pattern layer on the elastic layer, so that the color pattern layer has excellent sturdiness against peeling and light.

### BRIEF DESCRIPTION OF THE DRAWINGS

FIG. 1 is a schematic view of an artificial leather according to the present invention;

FIG. 2 is a schematic view of an artificial leather according to another aspect of the present invention; and

FIG. 3 is a flow chart of a method for manufacturing an artificial leather according to the present invention.

### DETAILED DESCRIPTION OF THE INVENTION

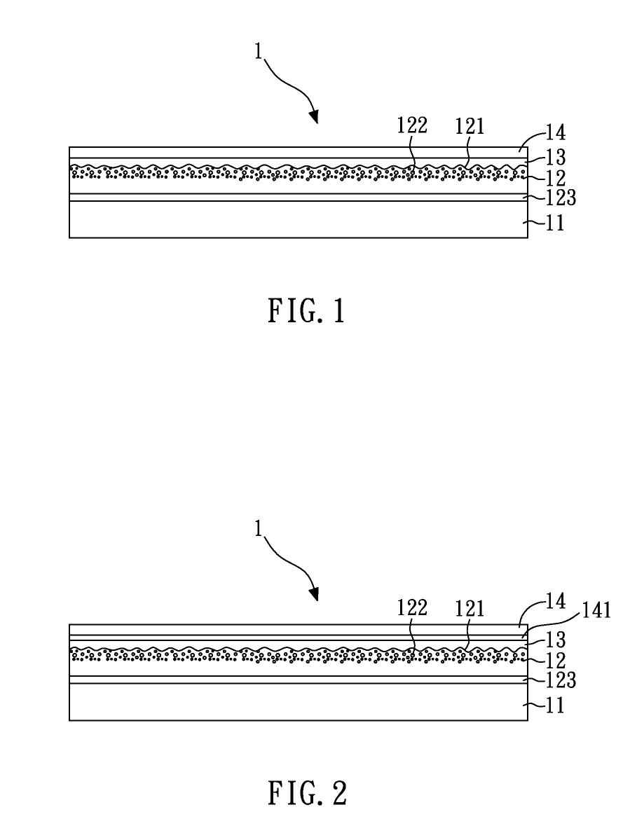

FIG. 1 is a schematic view of an artificial leather according to the present invention. As shown in FIG. 1, the artificial leather 1 includes a base material 11, an elastic layer 12, a color pattern layer 13, and a cover layer 14. In this embodiment, a material of the base material 11 is a non-woven fabric, the base material 11 is preferably a superfine fiber base material (having a fiber fineness of approximately 0.5 denier to approximately 0.0001 denier), and the thickness of the base material 11 is preferably 0.1-3 mm.

The elastic layer 12 is disposed on a surface of the base material 11, and the elastic layer 12 has an uneven surface 121 and includes a plurality of sparkling materials 122. The elastic layer 12 includes a polyurethane resin, or the elastic layer 12 is selected from a group consisting of a nitrocellulose resin and a polyethylene resin. In this embodiment, the sparkling material 122 is pearl powder, and the size of the sparkling material 122 is preferably 1-300 μm. The content of the sparkling material 122 is 0.1-10 percent by weight of the elastic layer 12. The distance between neighboring protrusions of the uneven surface 121 is preferably 1-500 μm. The height difference between a protruding peak and a recessed valley of the uneven surface 121 is preferably 1-500 μm.

It should be noted that in this embodiment, an elastic resin layer 123 is first formed on the surface of the base material 11, and then the elastic layer 12 is disposed on the elastic resin layer 123. However, in other applications, the artificial leather 1 may not include the elastic resin layer 123, and the elastic layer 12 is directly disposed on the base material 11.

The color pattern layer 13 is disposed on the uneven surface 121. The sparkling material 122 may reflect light to make it pass through the color pattern layer 13, so that the artificial leather 1 has a sparkling effect. In addition, with the structure of the uneven surface 121, the color distribution and the pattern size in the color pattern layer 13 may be further changed or enlarged, so as to achieve a sparkling effect at various angles by showing the gradation of the stacking particles.

The cover layer 14 covers the color pattern layer 13. In this embodiment, the cover layer 14 is a resin layer, which may be of a transparent or a light transmissive colored material. The cover layer 14 may include a polyurethane resin, or the cover layer 14 is selected from a group consisting of an acrylic resin and a copolymer resin or is selected from a group consisting of a nitrocellulose resin and a polyethylene resin. Preferably, the content of solid components in the cover layer 14 is higher than 40%, and the thickness of the cover layer 14 is 10-100 μm, so that the cover layer 14 has sufficient thickness to protect the color pattern layer 13 from being peeled under an external force, thus ensuring that the color pattern layer 13 has an excellent sturdiness against peeling.

It should be noted that the artificial leather 1 further includes an adhesive layer 141 (as shown in FIG. 2), and the cover layer 14 is adhered to the color pattern layer 13 through the adhesive layer 141. Here, the cover layer 14 includes a one-component polyurethane resin composition, and the adhesive layer 141 includes a two-component polyurethane resin composition. Through the disposition of the adhesive layer 141, the sturdiness against peeling of the color pattern layer 13 may be further enhanced.

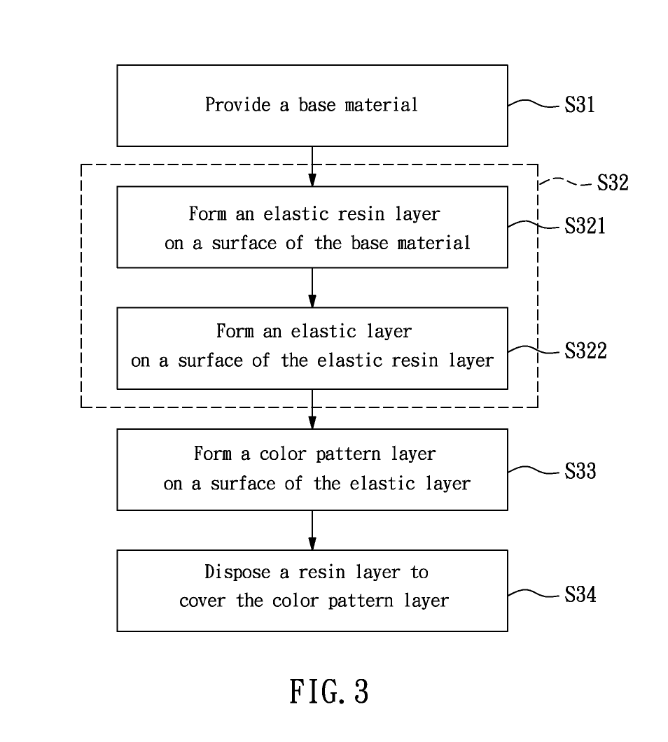

FIG. 3 is a flow chart of a method for manufacturing an artificial leather according to the present invention. As shown in FIGS. 2 and 3, first, in step S31, a base material 11 is provided. In step S32, an elastic layer 12 is disposed on a surface of the base material 11, and the elastic layer 12 has an uneven surface 121 and includes a plurality of sparkling materials 122.

In this embodiment, step S32 includes the following steps. In step S321, an elastic resin layer 123 is formed on the surface of the base material 11. In step S322, the elastic layer 12 is formed on a surface of the elastic resin layer 123. Step S321 further includes impregnating, solidifying, rinsing, drying, and other wet processes in sequence. That is to say, first the base material 11 is impregnated in an elastic resin solution, and then the solidifying, rinsing, drying, and other wet processes are performed on the base material 11 having the impregnated elastic resin, so as to form the elastic resin layer 123. Next, the elastic resin solution is coated on the surface of the elastic resin layer 123, so as to form the elastic layer 12.

In other applications, in step S32, the elastic resin solution is directly coated on the surface of the base material 11 in a coating manner, so as to form the elastic layer 12, and the impregnating, solidifying, rinsing, drying, and other steps are omitted.

In step S33, a color pattern layer 13 is disposed on the uneven surface 121. In step S33, the color pattern layer 13 may be disposed on the uneven surface 121 through an ink jet printing process or a thermal transfer process.

In step S34, a cover layer 14 is disposed to cover the color pattern layer 13, for protecting the color pattern layer 13, so as to finish fabricating the artificial leather 1 according to the present invention. In this embodiment, in step S34, the cover layer 14 is disposed to cover the color pattern layer 13 in the coating manner. It should be noted that in other applications, step S34 may further include coating a resin on a surface of a release paper to form the cover layer 14, adhering the cover layer 14 to the color pattern layer 13 (through the adhesive layer 141), and removing the release paper.

A detailed description of the present invention is given with reference to the embodiments as follows, but the present invention is not limited to the embodiments.

### First Embodiment

In this embodiment, a non-woven fabric base material is prepared by using 3 denier polyester fiber and 6 denier polyamide fiber in a cotton blending manner. Then, the base material is impregnated by using a polyurethane resin. Next, the polyurethane resin is spin-coated evenly on the impregnated base material in a blade coating manner. Next, the base material undergoes solidifying, rinsing at 90° C., and drying at 140° C., and then a first semi-finished product is manufactured. The first semi-finished product can be considered as including the base material 11 and the elastic resin layer 123 formed on the surface of the base material 11 in FIG. 1.

Next, a one-component polyurethane resin is diluted to a viscosity being 1200 cps and is toned to serve as a coating material. Then, 4% silver particles (sparkling material) having a particle diameter of 8-12 μm are added to the coating material, and fully dispersed and mixed. The coating material is then directly coated on a release paper (having an adsorption capacity of 150 g/m²). Next, the release paper is completely dried at 100° C.-150° C. to form a film, a layer of two-component polyurethane binding agent (having an adsorption capacity of 150 g/m²) having a viscosity of 6500 cps is coated on the release paper, and then the release paper is adhered to the first semi-finished product after the release paper is half-dried at 60° C.-90° C. After ripening and crosslinking (usually in an environment of 60° C. for 24 hours), the release paper is peeled to obtain a second semi-finished product. The second semi-finished product can be considered as including the base material 11, the elastic resin layer 123 and the elastic layer 12 formed on the surface of the base material 11 in FIG. 1.

Next, a color pattern layer is formed on the second semi-finished product through ink jet printing. In this embodiment, the ink jet pigment is an aqueous pigment, and is sprayed at a spraying speed of 15 cm/min and a temperature of 80° C.-100° C. The aqueous pigment can be toned to include more than 15 colors according to the actual demand. After the color pattern layer is dried, a third semi-finished product is manufactured. The third semi-finished product can be considered as including the base material 11, the elastic resin layer 123, the elastic layer 12, and the color pattern layer 13 formed on the surface of the base material 11 in FIG. 1.

Finally, a layer of glaring surface aqueous PU treatment agent is coated on a surface of the color pattern layer by a coating table (to form the cover layer 14 in FIG. 1), so as to manufacture the artificial leather according to the present invention, which has patterns or grains, sparkling, shining, and bright-colored effects, and a high sturdiness against peeling.

A tension test shows that the sturdiness against peeling of the artificial leather made according to this embodiment can be higher than 4.5 kg/cm.

### Second Embodiment

In this embodiment, a non-woven fabric base material is manufactured by using a 6 denier polyamide superfine fiber. Then, the base material is impregnated by using a polyurethane resin (including a polyurethane composition and DMF having a weight ratio of 40:60). Next, the impregnated base material undergoes solidifying, rising at 90° C., and drying at 140° C., and then a weight reducing process is carried out to lower the denier of the polyamide to 0.05 denier, so that a first semi-finished product is manufactured. The first semi-finished product can be considered as including the base material 11 and the elastic resin layer 123 formed on the surface of the base material 11 in FIG. 2.

Next, a one-component polyurethane resin is diluted to a viscosity being 1200 cps and is toned to serve as a coating material. Then, 1% silver particles having a particle diameter of 8-12 μm are added to the coating material, and then fully dispersed and mixed. The coating material is directly coated on a release paper (having an adsorption capacity of 180 g/m²) having triangle pyramid geometrical shapes overspreading thereon, and the triangle pyramid geometrical shapes have a size of 80 μm and a height difference of 30 μm between a peak and a valley.

Next, the release paper completely dried at 100° C.-130° C. to form a film, a layer of two-component polyurethane binding agent (having an adsorption capacity of 180 g/m²) having a viscosity of 6500 cps is coated on the release paper, and then the release paper is adhered to the first semi-finished product after the release paper is half-dried at 60° C.-90° C. After ripening and crosslinking (usually in an environment of 60° C. for 24 hours), the release paper is peeled to obtain a second semi-finished product. The second semi-finished product can be considered as including the base material 11, the elastic resin layer 123 and the elastic layer 12 formed on the surface of the base material 11 in FIG. 2.

Next, various color ink jet pigments are coated on a surface of the second semi-finished product through ink jet printing, so as to form a color pattern layer. In this embodiment, the ink jet pigment is an environmental-protective oil pigment, and is sprayed at a spraying speed of 16 m²/hr and a drying temperature being 90° C. After the color pattern layer is dried, a third semi-finished product is obtained. The third semi-finished product can be considered as including the base material 11, the elastic resin layer 123, the elastic layer 12, and the color pattern layer 13 formed on the surface of the base material 11 in FIG. 2.

Next, the one-component polyurethane resin having a sunscreen agent is coated on a flat release paper having a glaring surface, so as to form a transparent resin layer. After the resin layer is dried at 120° C., the two-component polyurethane resin (having a viscosity of 6500 cps) is coated on the resin layer to serve as a binding layer (equivalent to the adhesive layer 141 in FIG. 2). In this embodiment, the resin layer is adhered to a surface of the third semi-finished product through the binding layer. After the binding layer is ripened, the release paper is peeled, so as to manufacture the artificial leather according to the present invention, which has a multi-color sparkling effect at various angles with a three-dimensional geometric refraction and glittering micro-particles, and a high sturdiness against peeling.

A tension test shows that the sturdiness against peeling of the artificial leather made according to this embodiment can be higher than 4.0 kg/cm.

### Third Embodiment

In this embodiment, a non-woven fabric base material is manufactured by using a polyamide-6 superfine fiber. Then, the base material is impregnated by using a polyurethane resin (including a polyurethane composition and DMF having a weight ratio of 40:60). Next, the impregnated base material undergoes solidifying, rising at 90° C., and drying at 140° C., and then a weight reducing process is carried out to lower the denier of the polyamide to 0.001 denier, so that a first semi-finished product is manufactured. The first semi-finished product can be considered as including the base material 11 and the elastic resin layer 123 formed on the surface of the base material 11 in FIG. 2.

Next, a one-component polyurethane resin is diluted to a viscosity of 1200 cps and is toned to serve as a coating material. Then, a 1% mica powder in a sheet shape and having irregular sizes of 20-30 μm is added to the coating material, and then fully dispersed and mixed. The coating material is directly coated on a release paper (having an adsorption capacity of 160 g/m²) having a roughness of 50-60 μm. Next, the release paper is completely dried at 100° C.-130° C. to form a film, a layer of two-component polyurethane binding agent (having an adsorption capacity being 160 g/m²) having a viscosity of 6500 cps is coated on the release paper, and then the release paper is adhered to the first semi-finished product after the release paper is half-dried at 60° C.-90° C. After ripening and crosslinking (usually in an environment of 60° C. for 24 hours), the release paper is peeled to obtain a second semi-finished product. The second semi-finished product can be considered as including the base material 11, the elastic resin layer 123 and the elastic layer 12 formed on the surface of the base material 11 in FIG. 2.

Next, various color ink jet pigments are coated on a surface of the second semi-finished product through ink jet printing, so as to form a color pattern layer. In this embodiment, the ink jet pigment is an environmental-protective oil pigment, and is sprayed at a spraying speed of 16 m²/hr and a drying temperature of 90° C. After the color pattern layer is dried, a third semi-finished product is obtained. The third semi-finished product can be considered as including the base material 11, the elastic resin layer 123, the elastic layer 12, and the color pattern layer 13 formed on the surface of the base material 11 in FIG. 2.

Next, the one-component polyurethane resin having a leather hand-feeling agent is coated on a release paper having leather grains, so as to form a transparent resin layer. After the one-component polyurethane resin is dried at 120° C., the two-component polyurethane resin (having a viscosity of 6500 cps) is coated on the resin layer to serve as a binding layer (equivalent to the adhesive layer 141 in FIG. 2). In this embodiment, the surface resin layer is adhered to a surface of the third semi-finished product through the binding layer. After the binding layer is ripened, the release paper is peeled to obtain the artificial leather according to the present invention, which has a sparkling effect by showing the colors and gradation of the stacking particles, and a high sturdiness against peeling.

A tension test shows that the sturdiness against peeling of the artificial leather made according to this embodiment can be higher than 4.5 kg/cm.

### Comparative Example

In the comparative example, a non-woven fabric base material is manufactured by using a 6 diner polyamide superfine fiber. Then, the base material is impregnated by using a polyurethane resin (including a polyurethane composition and DMF having a weight ratio of 40:60). Next, the impregnated base material undergoes solidifying, rising at 90° C. and drying at 140° C., and then a weight reducing process is carried out, so that a superfine fiber artificial leather semi-finished product is manufactured.

Next, after the artificial leather semi-finished product is ground and dyed, paper having printed multi-color patterns covers the artificial leather semi-finished product, and then a thermal transfer process at a temperature of 210° C. is performed for 20 seconds, so that the multi-color patterns on the paper are transferred to the artificial leather semi-finished product, thus obtaining an artificial leather having multi-color patterns.

The artificial leathers obtained in the first embodiment, the second embodiment, and the third embodiment according to the present invention are compared with the artificial leather having multi-color patterns obtained in the comparative example, and results are shown in Table 1 below.

TABLE 1

| | | Sturdiness | | | | |
|---|---|---|---|---|---|---|
| | Sturdiness | Against | Sturdiness | Sparkling | Various | Stacking |
| | Against Rub | Peeling | Against Light | Effect | Angles | Particles |
| First | Wet: 5.0 | 4.0 kg/cm | 4.5 | ◯ | X | X |
| Embodiment | Dry: 5.0 | | | | | |
| Second | Wet: 4.5 | 4.0 kg/cm | 4.5 | ◯ | ◯ | X |
| Embodiment | Dry: 5.0 | | | | | |
| Third | Wet: 5.0 | 4.5 kg/cm | 4.5 | ◯ | X | ◯ |
| Embodiment | Dry: 5.0 | | | | | |
| Comparative Example | Wet: 3.0 | 3.0 kg/cm | 3.0 | X | X | X |
| | Dry: 3.5 | | | | | |

In Table 1, the sturdiness against rub is tested according to test method AATCC-8 of American Association of Textile Chemists and Colorists (AATCC). Each embodiment has “dry” and “wet” data, which are obtained by rubbing a test cloth against the artificial leather in dry and wet states, respectively. The sturdiness against peeling is tested according to AATCC-136. The sturdiness against light is tested after placing the artificial leather to be tested in an ultraviolet case having ultraviolet lamps of 30 watts for 16 hours, and the results can be divided into Levels 1-5, Level 1 represents “poor,” and Level 5 represents “excellent.” It can be seen from the comparison results of Table 1 that, compared with the artificial leather of the comparative example, the artificial leathers of the first embodiment, the second embodiment, and the third embodiment according to the present invention have better sturdiness against rub, peeling, and light.

The visual effect (Sparkling Effect) cannot be compared by using a digitizing instrument, so the visual effect is judged directly by the visual sense of human eyes and denoted as “O” or “X”. The term “O” here refers to “yes” and the term “X” here refers to “no”. The artificial leathers of the first embodiment, the second embodiment, and the third embodiment according to the present invention have the sparkling effect, and the sparkling effect can be controlled at various angles and by showing the gradation of the stacking particles, but the artificial leather of the comparative example does not have such effects.

In addition, in the method for manufacturing the artificial leather according to the present invention, after being designed by a computer graphic technique, the multi-color patterns of the color pattern layer are output to the elastic layer by using the thermal transfer or the ink jet printing process once, and the design of the multi-color patterns can be easily altered by using the computer. Further, in the artificial leather according to the present invention, the resin layer protects the color pattern layer formed on the elastic layer in the thermal transfer or the ink jet printing process, so that the color pattern layer has the excellent sturdiness against peeling and light.

While embodiments of the present invention have been illustrated and described, various modifications and improvements can be made by those skilled in the art. The embodiments of the present invention are therefore described in an illustrative but not restrictive sense. It is intended that the present invention is not limited to the particular forms as illustrated, and that all modifications that maintain the spirit and scope of the present invention are within the scope defined in the appended claims.

What is claimed is:

1. An artificial leather, comprising:
a base material;
an elastic layer, disposed on a surface of the base material, having an uneven surface, and comprising a plurality of sparkling materials;
a color pattern layer, disposed on the uneven surface; and
a cover layer, covering the color pattern layer.

2. The artificial leather according to claim 1, wherein a material of the base material is a non-woven fabric.

3. The artificial leather according to claim 1, wherein the base material is a superfine fiber base material, and the fiber fineness is 0.5-0.0001 denier.

4. The artificial leather according to claim 1, wherein the elastic layer comprises a polyurethane resin.

5. The artificial leather according to claim 1, further comprising an elastic resin layer disposed on the surface of the base material.

6. The artificial leather according to claim 1, wherein the sparkling material is 1-300 μm pearl powder.

7. The artificial leather according to claim 1, wherein the height difference between a protruding peak and a recessed valley of the uneven surface is 1-500 μm.

8. The artificial leather according to claim 1, wherein the cover layer is a transparent or a light transmissive colored resin layer.

9. The artificial leather according to claim 8, wherein the resin layer comprises a polyurethane resin.

10. The artificial leather according to claim 8, wherein the content of solid components in the resin layer is higher than 40%.

11. The artificial leather according to claim 1, further comprising an adhesive layer covering the color pattern layer.

12. The artificial leather according to claim 11, wherein the cover layer comprises a one-component polyurethane resin composition, and the adhesive layer comprises a two-component polyurethane resin composition.

13. A method for manufacturing an artificial leather, comprising:
(a) providing a base material;
(b) disposing an elastic layer on a surface of the base material, wherein the elastic layer has an uneven surface and comprises a plurality of sparkling materials;
(c) disposing a color pattern layer on the uneven surface; and
(d) disposing a cover layer to cover the color pattern layer.

14. The manufacturing method according to claim 13, wherein step (b) comprises:
(b1) forming an elastic resin layer on the surface of the base material; and
(b2) forming the elastic layer on a surface of the elastic resin layer.

15. The manufacturing method according to claim 14, wherein step (b1) further comprises impregnating, solidifying, rinsing, and drying steps in sequence.

16. The manufacturing method according to claim 13, wherein step (b) comprises:
(b1) impregnating the base material by using a polyurethane resin; and
(b2) spin-coating the polyurethane resin evenly on the impregnated base material to form the elastic layer.

17. The manufacturing method according to claim 13, wherein in step (c), the color pattern layer is disposed on the uneven surface through a thermal transfer process.

18. The manufacturing method according to claim 13, wherein in step (c), the color pattern layer is disposed on the uneven surface through an ink jet printing process.

19. The manufacturing method according to claim 13, wherein in step (d), the cover layer is disposed in a coating manner to cover the color pattern layer.

20. The manufacturing method according to claim 13, wherein step (d) comprises:
(d1) forming the cover layer on a surface of a release paper;
(d2) adhering the cover layer to the color pattern layer; and
(d3) removing the release paper.
